(19) United States
(12) Patent Application Publication
(10) Pub. No.: US 2010/0073684 A1
(43) Pub. Date: Mar. 25, 2010

(54) XY STAGE APPARATUS

(75) Inventors: Noboru KOBAYASHI, Kanagawa (JP); Yoshitaka KOGURE, Kanagawa (JP); Kenichi TAKAHARA, Tokyo (JP); Nobutaka KIKUIRI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Advanced Mask Inspection Technology, Yokohama-shi (JP)

(21) Appl. No.: 12/535,055

(22) Filed: Aug. 4, 2009

(30) Foreign Application Priority Data
Sep. 25, 2008 (JP) 2008-245090

(51) Int. Cl. G01B 11/02

(52) U.S. Cl. 356/500

(57) ABSTRACT

An XY stage apparatus capable of reducing a measurement error due to air fluctuations is provided. The XY stage apparatus includes a stage that moves in the XY directions, a laser interferometer to measure a position of the stage, and a measuring optical path barrel mechanism having a fixed barrel that covers at least a portion of a measuring optical path between the stage and the laser interferometer, is provided on a side of the laser interferometer of the measuring optical path, and is fixed to the laser interferometer and a movable barrel that covers at least a potion of the measuring optical path, is provided on the side of the stage of the measuring optical path, and moves together with movement of the stage, wherein an end of one of the fixed barrel and the movable barrel is inserted into that of the other.

### CROSS-REFERENCE TO RELATED APPLICATION

This application is based upon and claims the benefit of priority from Japanese Patent Applications No. 2008-245090, filed on Sep. 25, 2008, the entire contents of which are incorporated herein by reference.

### FIELD OF THE INVENTION

The present invention relates to an XY stage apparatus having a position measuring function by a laser interferometer.

### BACKGROUND OF THE INVENTION

It is known that a laser interferometer measuring machine operated in the air generally causes a measurement error due to changes of the environment such as atmospheric pressure, temperature, humidity, and air fluctuations. For long-term and gradual environmental changes such as atmospheric pressure, temperature, and humidity, a compensation method using the EDLEN formula is known. However, such a compensation method cannot provide compensation properties to relatively swift environmental changes such as air fluctuations. Particularly an influence of the air fluctuations on an XY stage and the like for which highly precise position measurement is required even in motion cannot be ignored.

As a technology to solve this problem, a method by which a laser interferometer to measure a stage position and a reference laser interferometer to measure a fixed position are provided and a measurement error of the stage position is corrected based on the measured value by the reference laser interferometer by assuming that environmental changes such as air fluctuations are the same for each laser interferometer is proposed (JP-A 2000-100704 (KOKAI)). JP-A 2000-100704 (KOKAI) also shows a method of reducing a measurement error due to air fluctuations by protecting a measuring optical path of a laser interferometer with a barrel-type jig.

Indeed, the technology of JP-A 2000-100704 (KOKAI) makes a complex optical system necessary because a reference laser interferometer is provided. Moreover, a structure in which measuring optical paths of a plurality of laser interferometers ideally adjacent to each other is difficult to implement and lacks stability of measurement error corrections because the same measuring environment cannot necessarily be guaranteed. Further, the proposal to protect a measuring optical path of a laser interferometer with a barrel-type jig is confined to a method of protecting a portion of the measuring optical path with a fixed barrel of the interferometer so that the reduction of a measurement error due to air fluctuations is not necessarily adequate.

### SUMMARY OF THE INVENTION

An XY stage apparatus according to an embodiment of the present invention includes a stage that moves in XY directions, a laser interferometer to measure a position of the stage, and a measuring optical path barrel mechanism having a fixed barrel that covers at least a portion of a measuring optical path between the stage and the laser interferometer, is provided on a side of the laser interferometer of the measuring optical path, and is fixed to the laser interferometer and a movable barrel that covers at least a portion of the measuring optical path, is provided on the side of the stage of the measuring optical path, and moves together with movement of the stage, wherein an end of one of the fixed barrel and the movable barrel is inserted into that of the other.

### BRIEF DESCRIPTION OF THE DRAWINGS

FIG. 1 is a top view of an XY stage apparatus according to a first embodiment;

FIG. 2 is a top view of an XY stage apparatus according to a second embodiment;

FIG. 3 is a diagram showing a spatial relationship between movement of an XY stage according to the second embodiment and a measuring optical path barrel mechanism;

FIG. 4 is a diagram showing a spatial relationship between movement of the XY stage according to the second embodiment and the measuring optical path barrel mechanism;

FIG. 5 is a diagram showing a spatial relationship between movement of the XY stage according to the second embodiment and the measuring optical path barrel mechanism;

FIG. 6 is a diagram showing a spatial relationship between movement of the XY stage according to the second embodiment and the measuring optical path barrel mechanism;

FIG. 7 is a diagram showing a spatial relationship between movement of the XY stage according to the second embodiment and the measuring optical path barrel mechanism;

FIG. 8 is a diagram showing a spatial relationship between movement of the XY stage according to the second embodiment and the measuring optical path barrel mechanism; and

FIG. 9 is a diagram showing a spatial relationship between movement of the XY stage according to the second embodiment and the measuring optical path barrel mechanism.

### DETAILED DESCRIPTION OF THE EMBODIMENTS

Embodiments of the present invention will be described with reference to drawings.

### First Embodiment

An XY stage apparatus in the first embodiment of the present invention has a stage that moves in the XY directions and a laser interferometer to measure the position of the stage. The XY stage apparatus also has a measuring optical path barrel mechanism including a fixed barrel that covers at least a portion of a measuring optical path between the stage and the laser interferometer, is provided on the laser interferometer side of the measuring optical path, and is fixed to the laser interferometer and a movable barrel that covers at least a portion of the measuring optical path, is provided on the stage side of the measuring optical path, and moves together with movement of the stage. The XY stage apparatus is also provided with a telescopic structure in which an end of one of the fixed barrel and the movable barrel is inserted into that of the other.

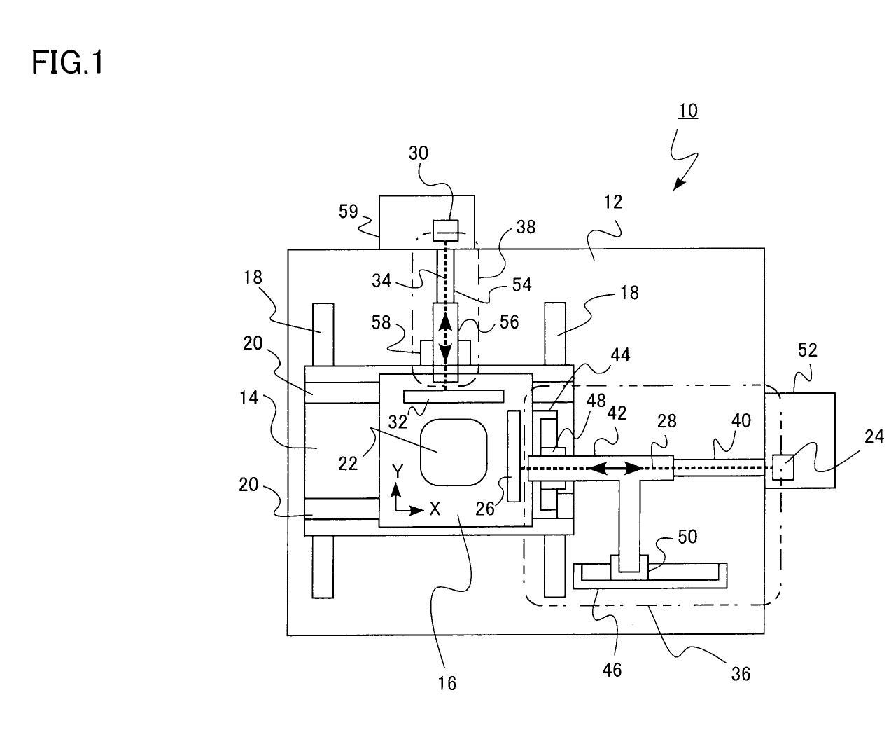

FIG. 1 is a top view of an XY stage apparatus according to the present embodiment. An XY stage apparatus 10 in the present embodiment is provided with an XY stage in a stack structure in which a Y stage 14 is mounted on a stage platen surface 12 and an X stage (or an XY stage) 16 is mounted on the Y stage 14.

The Y stage 14 moves in the Y direction along a Y air guide 18 fixed to the stage platen surface 12. The X stage 16 moves in the X direction along an X air guide 20 fixed to the Y stage 14. These mechanisms enable a work part 22 on the X stage 16 to move in the XY directions with respect to the stage platen surface 12.

Measurements of the position of the moving work part 22 in the X and Y directions are made by a laser interferometer and a reflector fixed to the vicinity of the work part 22. In the X-direction measurement, a laser light emitted from an X laser interferometer 24 is reflected by an X reflector 26 and an optical path length of an X measuring optical path 28 is measured by observing an interference wave of the emitted light and reflected light. Similarly in the Y-direction measurement, a laser light emitted from a Y laser interferometer 30 is reflected by a Y reflector 32 and an optical path length of a Y measuring optical path 34 is measured by observing an interference wave of the emitted light and reflected light.

In the XY stage apparatus 10 having a position measuring function by the laser interferometers 24 and 30, an X measuring optical path barrel mechanism 36 and a Y measuring optical path barrel mechanism 38 that cover substantially all areas of the X measuring optical path 28 and the Y measuring optical path 34 to the mechanical limit respectively are provided. The X measuring optical path barrel mechanism 36 has an X fixed barrel 40 that covers the X measuring optical path 28 between the X stage 16 and the laser interferometer 24, is provided on the laser interferometer 24 side of the X measuring optical path 28, and is fixed relatively to the laser interferometer 24. The X measuring optical path barrel mechanism 36 is also provided with a X movable barrel 42 that covers the X measuring optical path 28 and is provided on the X stage 16 side of the X measuring optical path 28, that is, on the X reflector 26 side fixed to the vicinity of the work part 22 of the X stage 16. The X measuring optical path barrel mechanism 36 also has a first slider mechanism 44 fixed to the X stage 16 and a second slider mechanism 46 fixed to the stage platen 12.

The first slider mechanism 44 allows the X stage 16 to move in a direction perpendicular to the X measuring optical path 28 even if the X fixed barrel 40 or the X movable barrel 42 is present. The second slider mechanism 46 allows the X stage 16 to move in a direction parallel to the X measuring optical path 28.

Here, an end of the X fixed barrel 40 is inserted into that of the X movable barrel 42 on a non-contact basis. Then, the X movable barrel 42 is held by both the first slider mechanism 44 and the second slider mechanism 46. More specifically, the X movable barrel 42 is held by being fixed to two locations of a Y slider part 48 of the first slider mechanism 44 and an X slider part 50 of the second slider mechanism 46.

When the X stage 16 is in motion, that is, the work part 22 moves in the X direction, which is in parallel with the X measuring optical path direction, the X movable barrel 42 moves together with the X stage 16 by a force in a direction perpendicular to the slide direction of the first slider mechanism 44 being transferred. Then, an action on the X fixed barrel 40 is supported with stability by the second slider mechanism 46 that allows the motion direction thereof.

When the Y stage 14 is in motion, that is, the work part 22 moves in the Y direction, the motion direction thereof is allowed by the first slider mechanism 44 without interfering with the X movable barrel 42. With a structure in which the slider mechanisms 44 and 46 are provided, an end of the X movable barrel 42 can be arranged up to the vicinity of the X reflector 26. Then, by integrally fixing the X fixed barrel 40 to an X laser interferometer cover 52, coverage of substantially all areas of the X measuring optical path 28 within the measuring range is realized to the mechanical limit. Here, coverage to the mechanical limit means that a distance between an end of the X movable barrel 42 and the X reflector 26 is reduced to a minimum distance at which the end of the X movable barrel 42 and the X reflector 26 do not come into contact during relative movement.

Like the X measuring optical path barrel mechanism 36, the Y measuring optical path barrel mechanism 38 is provided with a Y fixed barrel 54 arranged on the Y laser interferometer 30 side and a Y movable barrel 56 arranged on the Y reflector 32 side fixed to the vicinity of the work part 22. Then, by fixing the Y movable barrel 56 by a Y movable barrel holder 58 fixed to the Y stage 14 and integrally fixing the Y fixed barrel 54 to a Y laser interferometer cover 59, coverage of substantially all areas of the Y measuring optical path 34 is realized to the mechanical limit relatively easily without providing a slide mechanism such as the X measuring optical path barrel mechanism 36.

According to an XY stage apparatus in the present embodiment, a measurement error due to air fluctuations of a laser interferometer also during motion of the XY stage can be minimized by covering substantially all areas of a measuring optical path with a measuring optical path barrel to the mechanical limit. Therefore, an XY stage apparatus with improved reliability of position measurement can be provided.

From the viewpoint of minimizing a measurement error due to air fluctuations, it is desirable to set the distance between an end of a movable barrel and an X reflector to 5 mm or less.

While it is desirable that an end of a fixed barrel be inserted into that of a movable barrel on a non-contact basis, as described above, to eliminate an influence on an XY stage operation by contact, insertion while being brought in contact is not necessarily excluded. In FIG. 1, a structure in which an end of a fixed barrel is inserted into that of a movable barrel is taken as an example, but conversely, a structure in which an end of a movable barrel is inserted into that of a fixed barrel may also be adopted.

### Second Embodiment

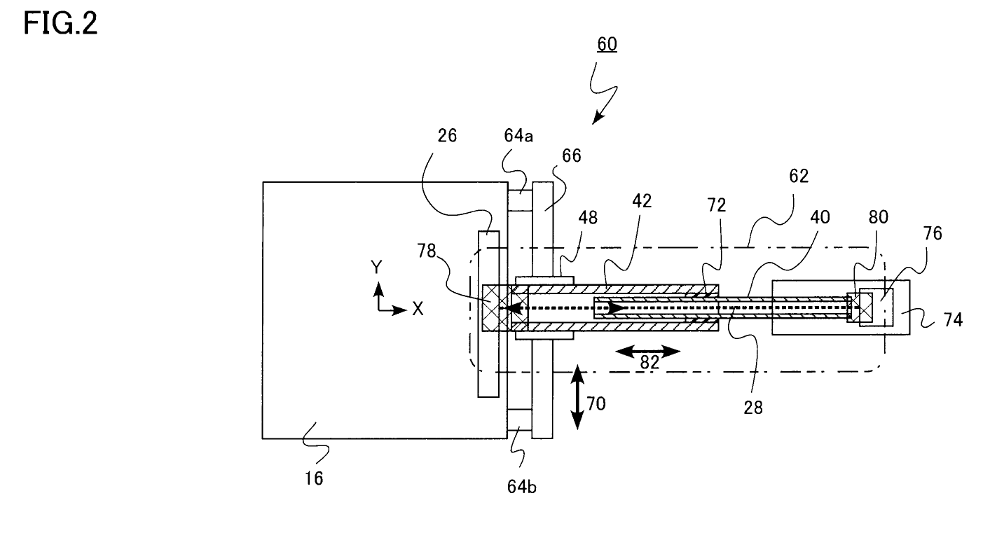

FIG. 2 is a top view of an XY stage apparatus according to the second embodiment. FIG. 2 shows an XY stage and a measuring optical path barrel mechanism of an XY stage apparatus 60 in the present embodiment by enlarging portions thereof. For the XY stage (X stage) 16, an illustration of a guide and the like is omitted for brevity. Explanation of the same aspects as those of the first embodiment is omitted herein.

The X reflector 26 is secured to the XY stage 16. A measuring optical path barrel mechanism 62 includes a Y slider mechanism axis 66 supported by the XY stage 16 via fixtures 64a and 64b, a Y slider part 48 that slides in a Y moving direction 70 along the Y slider mechanism axis 66, the X movable barrel (first measuring optical path barrel) 42 secured to the Y slider part 48, the X fixed barrel (second measuring optical path barrel) 40 telescopically supported via the X movable barrel (first measuring optical path barrel) 42 and an X slider part 72, an interferometer base 74 to which the X fixed barrel (second measuring optical path barrel) 40 is secured, and a mirror unit 76 that introduces the measuring optical path 28 of a laser interferometer to the X reflector 26.

Particularly the X movable barrel (first measuring optical path barrel) 42 and the X fixed barrel (second measuring optical path barrel) 40 are shown in FIG. 2 in cross sections thereof to explicitly show the measuring optical path 28 of the laser interferometer. An optical path shielding cover 78 is provided to prevent a flow of air generated in a gap between the X movable barrel 42 and the X reflector 26. Similarly, an optical path shielding cover 80 is provided to prevent a flow of air generated in a gap between the X fixed barrel 40 and the mirror unit 76.

The measuring optical path barrel mechanism 62 having the above configuration is configured to slide in an X moving direction 82 by forming guides of the X movable barrel 42 and the X fixed barrel 40 on inner and outer surfaces of the optical path barrel. Thus, compared with the measuring optical path barrel mechanism of the XY stage apparatus 10 in FIG. 1, there is no need to provide a guide separately, the number of parts is small, and the measuring optical path barrel mechanism will be more reliable. An air slider, magnetic slider, or rolling bearing is preferably applicable as the X slider part 72 formed on the inner and outer surfaces of the X movable barrel 42 and the X fixed barrel 40.

The optical path shielding covers 78 and 80 are capable of preventing a flow of air generated in a gap between the X movable barrel 42 and the X reflector 26 or between the X fixed barrel 40 and the mirror unit 76 so that more stable measurements can be made without allowing values of the laser interferometer to waver.

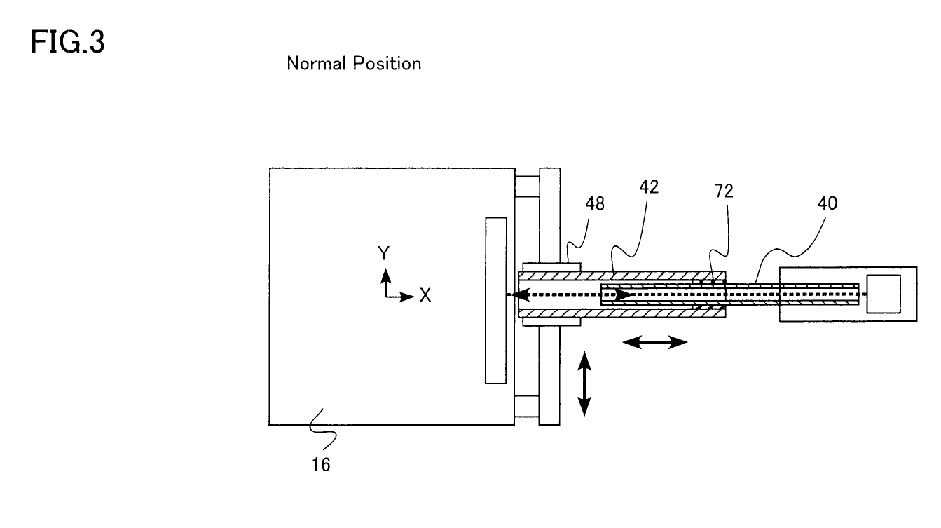

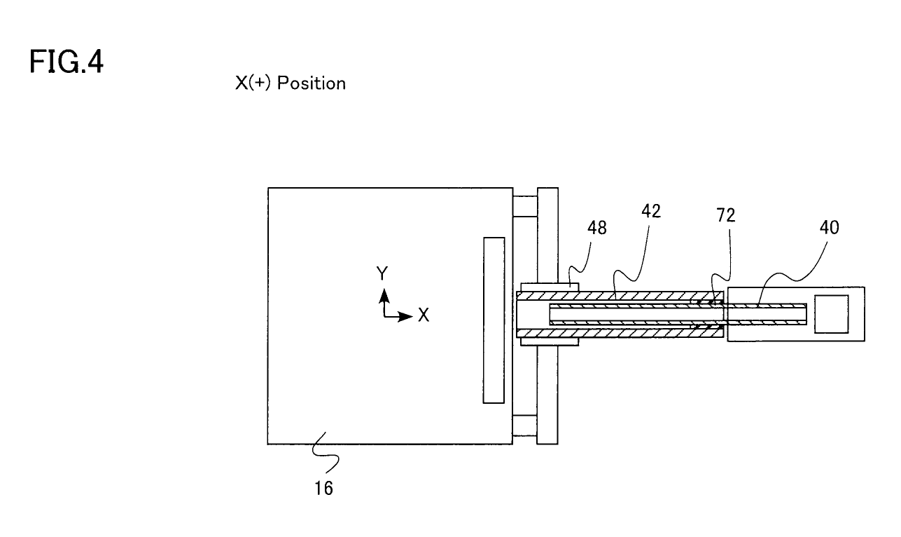

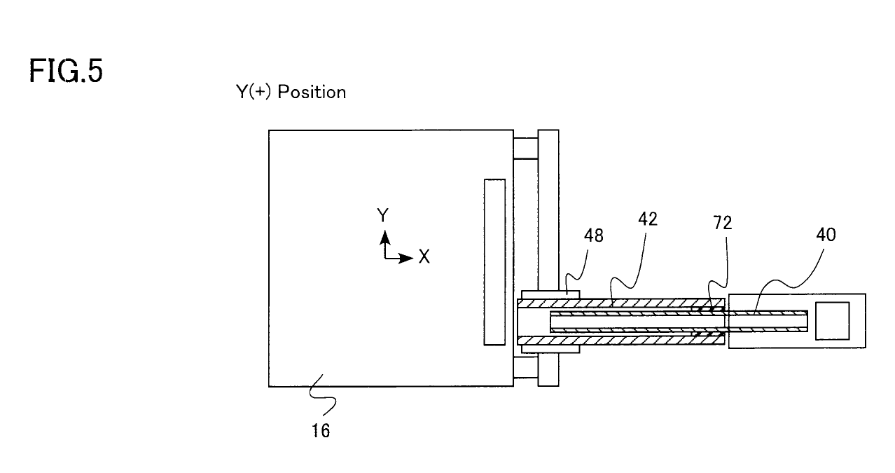

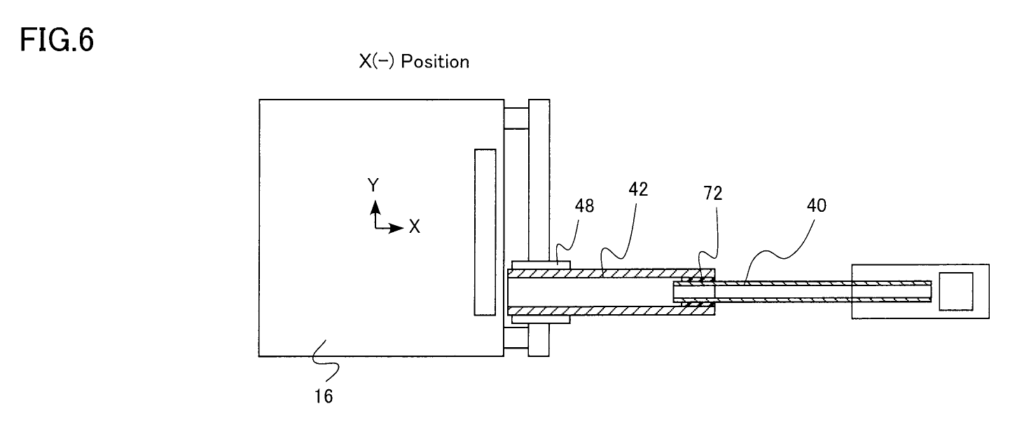

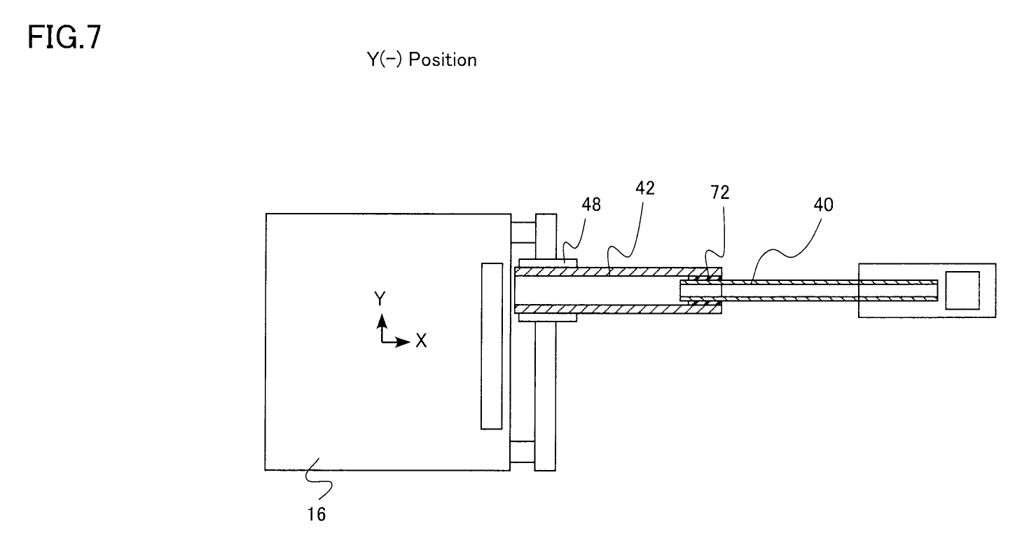

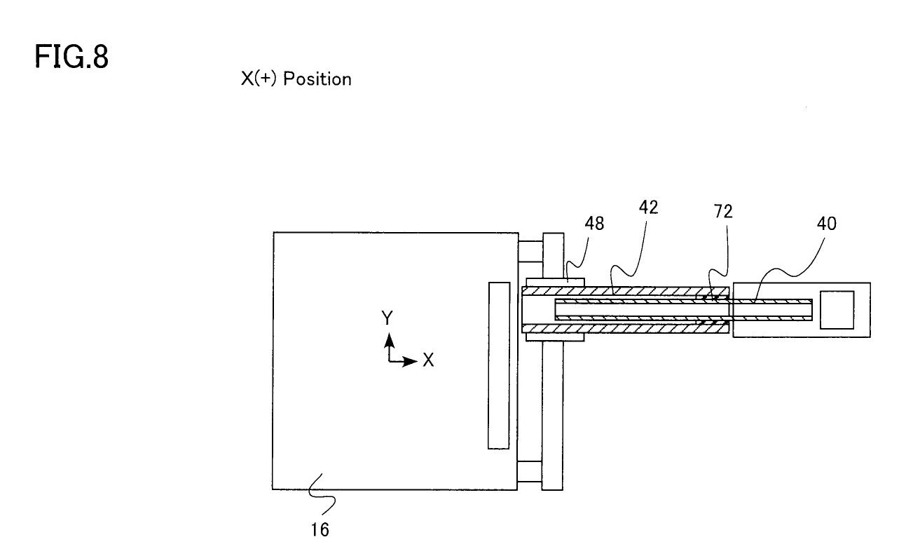

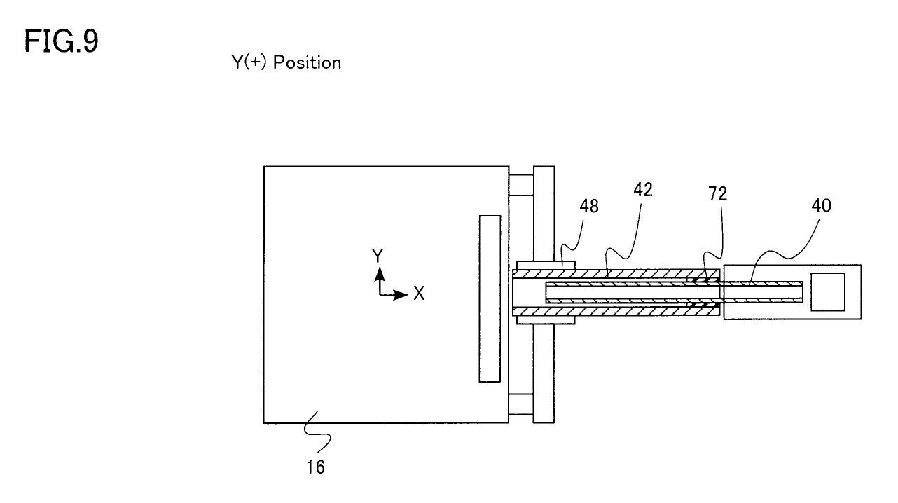

FIGS. 3 to 9 are diagrams showing spatial relationships between movement of the XY stage and the measuring optical path barrel mechanism. That is, spatial relationships among the X movable barrel 42, the X fixed barrel 40, and the slider parts 48 and 72 when the XY stage 16 is moved from the normal position to each position. Thus, even when the XY stage 16 is moved to various positions, the X movable barrel 42 and the X fixed barrel 40 play the role as an optical path cover.

According to an XY stage apparatus in the present embodiment, like an XY stage apparatus in the first embodiment, a measurement error due to air fluctuations of a laser interferometer also during motion of the XY stage can be minimized by covering substantially all areas of a measuring optical path with a measuring optical path barrel to the mechanical limit. Therefore, an XY stage apparatus with improved reliability of position measurement can be provided.

In the foregoing, embodiments have been described with reference to concrete examples. However, the present embodiment is not limited to these concrete examples. For example, each embodiment is described by taking an XY stage in a stack structure as an example, but the present invention is not limited to an XY stage in a stack structure and is applicable to a platen sliding XY stage and the like.

Though what is not directly needed to describe the present invention such as the apparatus configuration and control techniques is omitted, the needed apparatus configuration or control techniques can suitably be selected and used when necessary. In addition, all XY stage apparatuses that have elements of the present invention and whose design can be modified when necessary by persons skilled in the art are included in the scope of the present invention.

What is claimed is:

1. An XY stage apparatus, comprising:
a stage that moves in XY directions;
a laser interferometer configured to measure a position of the stage; and
a measuring optical path barrel mechanism having a fixed barrel that covers at least a portion of a measuring optical path between the stage and the laser interferometer, is provided on a side of the laser interferometer of the measuring optical path, and is fixed to the laser interferometer and a movable barrel that covers at least a potion of the measuring optical path, is provided on the side of the stage of the measuring optical path, and moves together with movement of the stage, wherein
an end of one of the fixed barrel and the movable barrel is inserted into that of the other.

2. The apparatus according to claim 1, wherein the end of the one and that of the other are mutually non-contact for insertion.

3. The apparatus according to claim 1, wherein substantially all areas of the measuring optical path are covered with the fixed barrel and the movable barrel.

4. The apparatus according to claim 2, wherein substantially all areas of the measuring optical path are covered with the fixed barrel and the movable barrel.

5. The apparatus according to claim 1, wherein the measuring optical path barrel mechanism, comprising:
a first slider mechanism allowing movement of the stage in a direction perpendicular to the measuring optical path; and
a second slider mechanism allowing movement of the stage in the direction parallel to the measuring optical path, wherein
the movable barrel is held by both the first slider mechanism and the second slider mechanism.

6. The apparatus according to claim 2, wherein the measuring optical path barrel mechanism, comprising:
a first slider mechanism allowing movement of the stage in a direction perpendicular to the measuring optical path; and
a second slider mechanism allowing movement of the stage in the direction parallel to the measuring optical path, wherein
the movable barrel is held by both the first slider mechanism and the second slider mechanism.

7. The apparatus according to claim 3, wherein the measuring optical path barrel mechanism, comprising:
a first slider mechanism allowing movement of the stage in a direction perpendicular to the measuring optical path; and
a second slider mechanism allowing movement of the stage in the direction parallel to the measuring optical path, wherein
the movable barrel is held by both the first slider mechanism and the second slider mechanism.

8. The apparatus according to claim 4, wherein the measuring optical path barrel mechanism, comprising:
a first slider mechanism allowing movement of the stage in a direction perpendicular to the measuring optical path; and
a second slider mechanism allowing movement of the stage in the direction parallel to the measuring optical path, wherein
the movable barrel is held by both the first slider mechanism and the second slider mechanism.

9. The apparatus according to claim 5, wherein the stage has a stack structure of a first stage that moves in the direction perpendicular to the measuring optical path and a second stage that moves in the direction parallel to the measuring optical path and
the first slider mechanism is fixed to the second stage and the movable barrel integrally moves with the second stage in the direction parallel to the measuring optical path.

10. The apparatus according to claim 8, wherein the stage has a stack structure of a first stage that moves in the direction perpendicular to the measuring optical path and a second stage that moves in the direction parallel to the measuring optical path and
the first slider mechanism is fixed to the second stage and the movable barrel integrally moves with the second stage in the direction parallel to the measuring optical path.
